(19) United States
(12) Patent Application Publication
(10) Pub. No.: US 2014/0118401 A1
(43) Pub. Date: May 1, 2014

(54) IMAGE DISPLAY APPARATUS WHICH DISPLAYS IMAGES AND METHOD THEREFOR

(71) Applicant: CASIO COMPUTER CO., LTD., Tokyo (JP)

(72) Inventor: Kazuyasu YAMANE, Tokyo (JP)

(73) Assignee: CASIO COMPUTER CO., LTD., Tokyo (JP)

(21) Appl. No.: 14/061,188

(22) Filed: Oct. 23, 2013

(30) Foreign Application Priority Data
Oct. 26, 2012 (JP) 2012-236390

(51) Int. Cl. G09G 5/377

(52) U.S. Cl. CPC G09G 5/377
USPC 345/636

(57) ABSTRACT

An object of the present invention is to provide an image display apparatus in which, when information is added to an object of interest to be focused in images, and the position of the object of interest to be focused is changed in the images, additional information can follow the change. When there occurs change in the imaging direction of a camera section, the correction process of the display position of the additional information is performed, in order to have the additional information to follow the positional change of the subject of interest to be focused (an object of interest to be focused) in the captured image (preview image), the display position of the additional information is updated and corrected to a new display position. Then, the additional information is combined and displayed at a display position which is acquired by the correction process on the preview screen.

### CROSS-REFERENCE TO RELATED APPLICATIONS

This application is based upon and claims the benefit of priority from the prior Japanese Patent Application No. 2012-236390, filed Oct. 26, 2012, the entire contents of which are incorporated herein by reference.

### BACKGROUND OF THE INVENTION

1. Field of the Invention

The present invention relates to an image display apparatus which displays images and a method for the image display apparatus.

2. Description of the Related Art

Conventionally, regarding image display apparatuses, which display images, such as portable terminal apparatuses, television receivers, and personal computers, for example, a composite display technology, in which arbitrary information (for example, character strings and marks) is superimposed on images such as captured images, television images, and projected images, is exemplified by a technology in which handwriting images are combined with lecture images, thereby displaying the combined images (see Japanese Patent Application Laid-Open (Kokai) Publication No. 2007-060032), or by a technology in which an image drawn by hand on a projected screen is combined with a projected image and displayed in accordance with the change of a projected image frame, thereby preventing misalignment between the projected image and the handwritten image (see Japanese Patent Application Laid-Open (Kokai) Publication No. 2007-017543).

However, the aforementioned conventional technologies are technologies in which handwritten information is combined with the image and displayed, and the image and the handwritten information are associated with each other.

By the way, when a subject such as a person is captured as an image, it is well known that arbitrary information is added at the position of the subject in the captured image, combined and displayed, which provides users with various pleasures and practical use in terms of imaging. However, when a camera slightly tilts after the information is associated and added to the subject in a live view display image, there is a possibility that association between the subject and the additional information is disrupted, which fails to realize the original intentions of adding the information. This is not limited to the captured images, but is similarly applied to images such as television images and projected images. When arbitrary information is added to a person in the images, and the person moves in the images, there is a possibility that the association between the subject and the additional information is disrupted, which fails to realize the original intentions of adding the information.

### SUMMARY OF THE INVENTION

An object of the present invention is to provide an image display apparatus in which, when arbitrary information which a user desires is added to an object of interest to be focused in images, and the position of the object of interest to be focused in the images is changed, additional information can follow the change.

The present invention provides an image display apparatus which displays images on a display section, comprising: a first display control section which associates an object of interest to be focused in an image displayed on the display section with additional information regarding the object of interest to be focused, combines the object with the additional information, and display the additional information in the image; a detection section which detects positional change of the object of interest to be focused in the image; and a second display control section which changes a display position of the additional information in accordance with the positional change of the object of interest to be focused, which is detected by the detection section, combines the additional information with the object of interest to be focused, and displays the additional information in the image.

According to one aspect of the present invention, when the arbitrary information which the user desires is added to the object of interest to be focused in the images, and the position of the object of interest to be focused in the images is changed, the additional information can follow the change, and association between the object of interest to be focused and the additional information can be maintained.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a diagram illustrating a communication system between a tablet terminal apparatus 1 and a personal computer 2;

FIG. 2 is a block diagram of the basic components of the tablet terminal apparatus 1;

FIG. 3A and FIG. 3B are diagrams for describing the movement or inclination of the tablet terminal apparatus 1;

FIG. 4 is a flowchart illustrating an operation when a mode is switched to a composite imaging mode;

FIG. 5 is a flowchart illustrating an operation subsequent to the operation in FIG. 4;

FIG. 6 is a flowchart for describing Step A13 in FIG. 5 in detail;

FIG. 7 is a diagram illustrating a display state in a case where tag information is combined and displayed in a captured image;

FIG. 8 is a diagram illustrating a size of a screen and a coordinate system on the screen;

FIG. 9 is a diagram for describing a person introduction table PT in a second embodiment;

FIG. 10 is a flowchart illustrating an operation in a person introduction mode in the second embodiment;

FIG. 11 is a flowchart illustrating an operation subsequent to the operation in FIG. 10;

FIG. 12 is a flowchart illustrating an operation subsequent to the operation in FIG. 11; and

FIG. 13A and FIG. 13B are diagrams illustrating a display state in a case where additional information is combined and displayed, in the second embodiment.

### DETAILED DESCRIPTION OF THE PREFERRED EMBODIMENTS

Embodiments of the present invention will hereinafter be described referring to drawings in detail.

### First Embodiment

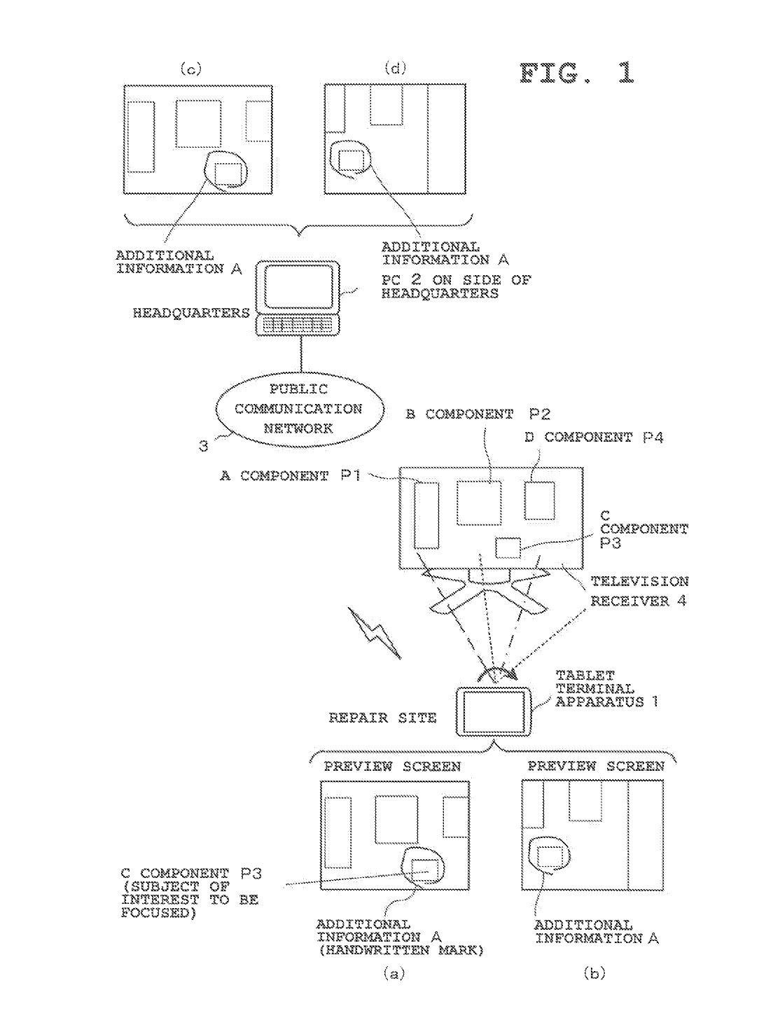

First, a first embodiment of the present invention will be described referring to FIG. 1 to FIG. 8.

In the present embodiment, the present invention has been a tablet terminal apparatus 1 with a camera function as an image display apparatus. FIG. 1 is a diagram illustrating a communication system (business communication system) in a case where business communication is performed between the tablet terminal apparatus 1 on the side of a repair site where electrical products are repaired on a visit and a personal computer 2 on the side of headquarters (PC on the side of headquarters). The entire shape of the tablet terminal apparatus 1 is formed in a thin, rectangular parallelepiped, and for example, exemplified by a portable information terminal apparatus of an A5 size. In the business communication system, the tablet terminal apparatus 1 is carried by a person in charge of repairs who repairs the electrical products on a visit and includes a camera (not shown in FIG. 1) on the back side thereof (the opposite side of a touch input screen), in addition to basic functions such as a touch input display function and a wireless communication function.

The person in charge of repairs uses the tablet terminal apparatus 1 prior to the repairs. When the electrical product targeted for the repairs is captured as an image, the captured image is transmitted to the PC 2 on the side of the headquarters via a public communication network 3 (a wireless communication network, the Internet). The example of FIG. 1 illustrates a case where a television receiver 4, whose back cover is removed, is captured as an electrical product targeted for the repairs, and where an A component P1, a B component P2, a C component P3, and a D component P4 are included in the captured image (static image) as a plurality of subjects. Thus, the captured images of the television receiver 4 are sequentially displayed on its own touch input screen, and also sequentially displayed on the screen of the PC 2 by being transmitted to the PC 2 on the side of the headquarters.

Herein, when persons at the repair site and the headquarters have a meeting with regards to the repairs while checking a common captured image, a person in charge of repairs at the repair site inputs additional information A associated with a position of a desired subject, that is, a position of the subject (the C component P3) in the example of FIG. 1, out of respective subjects (the A component P1, the B component P2, the C component P3, and the D component P4) in the captured image, which is displayed on the touch input screen of the tablet terminal apparatus 1. Herein, in the first embodiment, the additional information A is information regarding an arbitrary subject in the captured image which is associated with the subject and displayed. For examples, the additional information A means drawing information such as marks, symbols, and characters which are arbitrarily drawn by hand, or tag information such as character strings and symbols which are prepared in advance.

The example of FIG. 1 illustrates a case where a circular mark drawn by hand is inputted as the additional information A such that the C component P3 in the captured image is surrounded, in order to clarify that the C component P3 is an object of interest to be focused (for example, a component targeted for the repairs, or a component to be inquired). Thus, any of subjects in the captured image (the C component P3 in the example of FIG. 1) is recognized as the object of interest to be focused (subject of interest to be focused), and the additional information A regarding the subject is inputted while being associated with the subject of interest to be focused, whereby the additional information A is combined and displayed at a position of the subject of interest to be focused in the captured image.

Portion (a) of FIG. 1 illustrates a composite image in a case where the additional information A is combined and displayed at a position of the C component P3 as the subject of interest to be focused on the side of the tablet terminal apparatus 1. Also, portion (c) of FIG. 1 illustrates the composite image which is transmitted and displayed at the PC 2 on the side of the headquarters. Thus, the common composite images are respectively displayed on the sides of the repair site and the headquarters. Also, portions (b) and (d) of FIG. 1 illustrate a captured image (composite image) in a case where the capturing direction of the camera is changed corresponding to the movement or inclination of the tablet terminal apparatus 1. That is, in a state where the composite images as illustrated in portions (a) and (c) of FIG. 1 are displayed, when the capturing direction of the camera is changed corresponding to the movement or inclination of the tablet terminal apparatus 1, the position of the subject (C component P3) in the captured image is accordingly changed. In the case, as illustrated in portions (b) and (d) of FIG. 1, the display position of the additional information A is changed in accordance with the positional change of the C component P3, and the additional information A is combined and displayed.

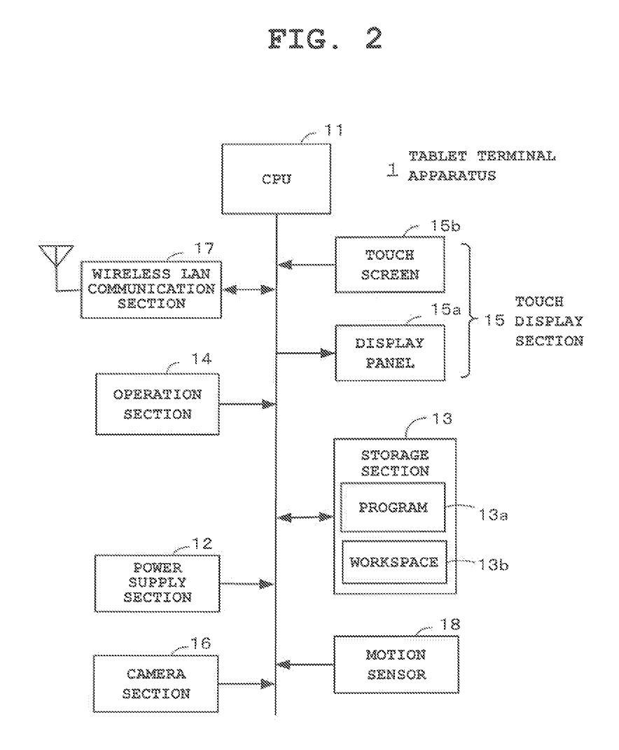

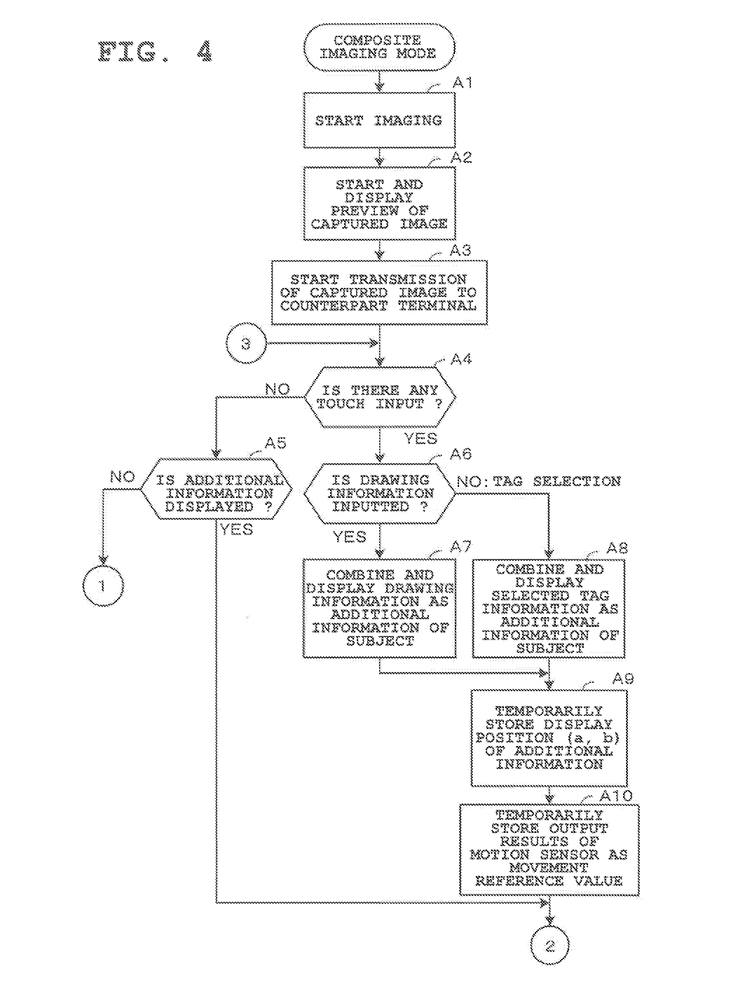

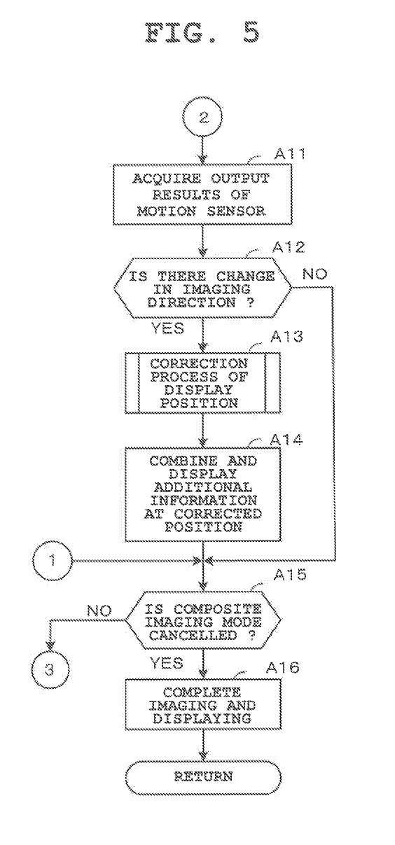

FIG. 2 is a block diagram of the basic components of the tablet terminal apparatus 1. A CPU 11 is operated by electric power supplied from a power supply section (secondary battery) 12 and is a central processing unit which controls the entire operation of the tablet terminal apparatus 1 in accordance with various programs in a storage section 13. The storage section 13 is constituted by, for example, a ROM (Read-Only Memory) and a flash memory. The storage section 13 further includes a program memory 13a which stores programs and various applications for achieving the embodiment of the present invention in accordance with operation procedures illustrated in FIG. 4 and FIG. 5, and a workspace memory 13b which temporarily stores various information (for example, flags) necessary for the tablet terminal apparatus 1 to be operated. Note that the storage section 13 may include, for example, a removable and transportable memory (recording medium) such as an SD (Secure Digital) card and an IC (Integrated Circuit) card. Although not shown, the storage section 13 may be configured to include a storage area on a predetermined server device side in a state where the storage section 13 is connected to a network by means of a communication function.

An operation section 14 includes, although not shown, a power key to turn the power supply ON/OFF, a shutter key to indicate imaging, and a mode switching key which switches between an imaging mode (a composite imaging mode in addition to a moving image mode and a continuous shot mode) and a playback mode, as push-button keys. Herein, the composite imaging mode is, for example, an operation mode in which, when the persons at the repair site and the headquarters have a meeting with regards to the repairs while checking the common captured image, as is described above, the additional information A regarding the subject is combined with the subject and displayed at the position of the subject of interest to be focused (object of interest to be focused) in the captured image.

A touch display section 15 is constituted such that the touch panel 15b is arranged to be laminated on the display panel 15a. The display panel 15a is a high-definition liquid-crystal display having a screen with an uneven aspect ratio, which serves as a monitor screen (live view screen) for displaying the captured image (live view image), or a playback screen for replaying the captured image, at the time of the aforementioned imaging mode. The touch panel 15b constitutes a touch screen for detecting a position touched with a finger of an imaging person and inputting coordinate data of the detected position. Note that, although a capacitive type or a resistive film type is adopted in this embodiment, another type may be adopted.

Also note that the touch operation is not limited to a contact operation by a finger or pen making contact with the touch panel 15b or making contact with and moving over the touch panel 15b. The touch operation includes, as an operation similar to the contact operation, a non-contact operation for which the position of a finger or a pen is detected based on changes in capacitance or brightness by the approach or the approach and movement of the finger or the pen. That is, the touch panel 15b is not limited to a contact-type touch panel which detects a contact operation, and may be a non-contact-type touch panel or operation detection device which detects a non-contact operation. In the present embodiment, however, the case of a contact operation is exemplarily described.

The camera section 16 constitutes a digital camera which can capture moving images in addition to static images, although not shown, and includes a taking lens, image sensor elements, various sensors, an analog processing section, and a digital processing section. The camera section 16 is capable of imaging a subject with high definition by forming a subject image from an optical lens onto an imaging element (such as a CCD (Charge-Coupled Device) or a CMOS (Complementary Metal-Oxide Semiconductor)). The camera section 16 includes various functions such as an automatic exposure adjustment function, an automatic focus adjustment function, and a zoom function. A wireless LAN (Local Area Network) communication section 17 is a wireless communication module that can perform high-speed and high-volume communication and can be connected to the Internet via a nearest wireless LAN router (not shown).

A motion sensor 18 is a sensor which detects movement or orientation of the tablet terminal apparatus 1 in three-dimensional space. For example, the motion sensor 18, although not shown, is constituted by an acceleration sensor which detects acceleration in the three-axis directions (X, Y, and Z directions) of the three-dimensional space, a direction sensor (magnetic field sensor) which detects the directions on the earth, and a gyro sensor (angular velocity sensor) which detects an angular velocity and thereby detects inclination. When the imaging direction of the camera section 16 is changed due to the change of movement or orientation of the tablet terminal apparatus 1, the CPU 11 detects the amount of change in the direction based on the output results of the motion sensor 18.

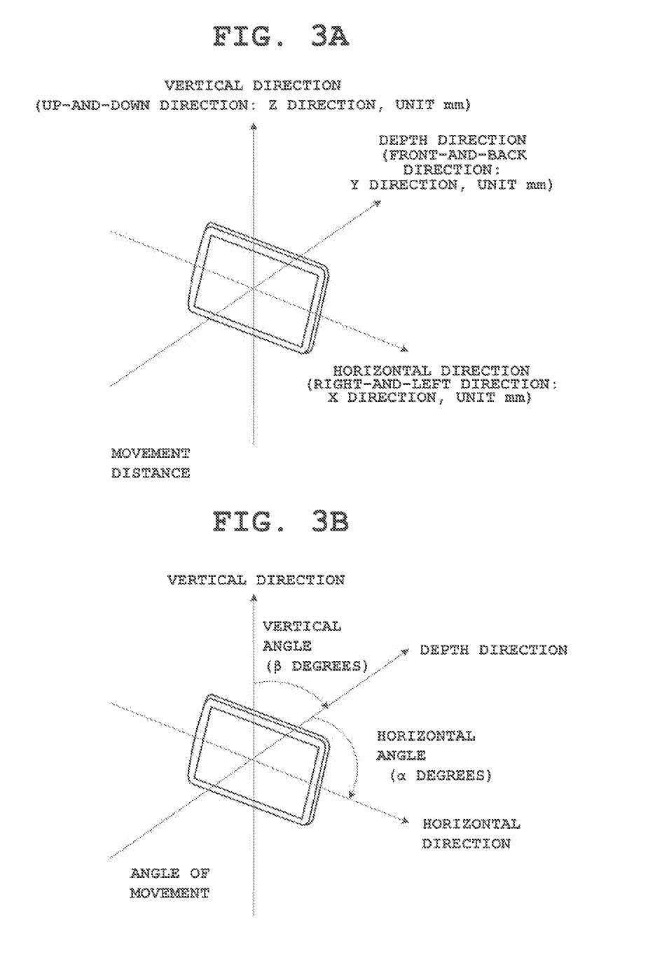

FIG. 3A and FIG. 3B are diagrams illustrating the movement or inclination of the tablet terminal apparatus 1, which the motion sensor 18 detects in the three-dimensional space made up of a horizontal direction (right-and-left direction: X direction), a depth direction (front-and-back direction: Y direction), and a vertical direction (up-and-down direction: Z direction). FIG. 3A shows that the motion sensor 18 detects the amount of movement (unit: mm) of the tablet terminal apparatus 1, in a case where the tablet terminal apparatus 1 in the three-dimensional space moves in the horizontal direction (right-and-left direction), the depth direction (front-and-back direction), or the vertical direction (up-and-down direction) with reference to the imaging position of the tablet terminal apparatus 1 at the time point when the aforementioned additional information A is combined and displayed. FIG. 3B shows that the motion sensor 18 detects a horizontal angle (α degrees) formed by the horizontal direction and the depth direction and a vertical angle (β degrees) formed by the depth direction and the vertical direction as the amount of inclination, in a case where the tablet terminal apparatus 1 in the three-dimensional space tilts with reference to the imaging direction of the tablet terminal apparatus 1 as a reference at the time point when the aforementioned additional information A is combined and displayed.

At the time of the aforementioned composite imaging mode, the CPU 11 judges whether or not the tablet terminal apparatus 1 has moved or tilted (whether the imaging direction of the camera section 16 has been changed) based on the output results of the motion sensor 18 in a state where the captured image (live view image) is displayed on the touch display section 15. Herein, when the imaging direction of the camera section 16 is changed due to the movement or inclination of the tablet terminal apparatus 1, the display position of the subject in the captured image (live view image) displayed on the live view screen of the touch display section 15 is changed. Accordingly, the display position of the additional information A associated with the subject is similarly changed in accordance with the change of the display position of the subject. In this case, the CPU 11 calculates a new display position of the additional information A in consideration of the screen size and dot pitches of the display panel 15a and the viewing angle of the camera section 16 and then combines and displays the additional information A at the calculated position.

Next, the operational concept of the tablet terminal apparatus 1 of the first embodiment is described referring to flowcharts illustrated in FIG. 4 to FIG. 6. Herein, each function described in the flowcharts is stored in readable program code format and operations based on these program codes are sequentially performed. Also, operations based on the above-described program codes transmitted over a transmission medium such as a network can also be sequentially performed. That is, the unique operations of the present embodiment can be performed using programs and data supplied from an outside source over a transmission medium, in addition to a recording medium. This applies to other embodiments described later. Note that FIG. 4 and FIG. 5 are the flowcharts outlining the operation of a characteristic portion of the present embodiment, from among all of the operations of the tablet terminal apparatus 1. After exiting the flows in FIG. 4 and FIG. 5, the process is returned to the main flow (not shown) of the entire operations.

FIG. 4 and FIG. 5 are the flowcharts illustrating the operation which is started in a case of switching from the present mode to the composite imaging mode through the operation of the aforementioned mode switching key. When the present mode is switched to the composite imaging mode in order that persons at the repair site and the headquarters have a meeting with regards to the repairs while checking a common captured image, the CPU 11 of the tablet terminal apparatus 1 operates the camera section 16 and causes the camera section 16 to start capturing an image (Step A1 in FIG. 4). Then, the CPU 11 acquires the captured image from the camera section 16 and causes the touch display section 15 to start a preview display in which the captured image is displayed as a preview image (Step A2) and starts the operation of transmitting the captured image (preview image) to the PC 2 on the side of the headquarters, which is a counterpart terminal (Step A3). In this case, the PC 2 on the side of the headquarters receives the captured image from the tablet terminal apparatus 1 and starts the display operation by which the captured image is sequentially displayed on its own screen.

Thus, the CPU 11 judges whether or not a touch input operation has been performed in a state where the captured image is displayed on the touch display section 15 as the preview image (Step A4). Herein, the touch input operation in the composite imaging mode is performed so as to input the aforementioned additional information A (drawing information or tag information) on the preview screen. When the touch input operation is not performed (Step A4, NO), that is, when the additional information A is not inputted, the process proceeds to Step A5, and the CPU 11 judges whether or not the additional information A has been combined and displayed in the preview screen. Since any of the additional information A is not displayed at the first time point of switching to the composite imaging mode (Step A5, NO), the process proceeds to Step A15 in FIG. 5, and the CPU 11 judges whether or not the aforementioned composite imaging mode has been cancelled, thereby being completed. Herein, when the current mode remains set to the composite imaging mode (Step A15, NO), the CPU 11 returns the process to Step A4 in FIG. 4 and judges whether or not the touch input operation is performed.

When the touch input operation for inputting the additional information A (drawing information or tag information) on the preview screen is performed (Step A4, YES), the CPU 11 judges whether or not the touch input operation is an operation of inputting the drawing information (Step A6). Here, in the example of FIG. 1, a person in charge of repairs at the repair site pays attention to a component (the C component P3) as a subject of interest to be focused, out of the respective subjects (the A component P1, the B component P2, the C component P3, and the D component P4) in the captured image. In order to clarify a component targeted for the repairs, or a component to be inquired, when the person in charge of repairs at the repair site draws additional information A such that the subject of interest to be focused is surrounded, the CPU 11 judges that the touch input operation of inputting the drawing information is performed at Step A6.

Thus, when arbitrary additional information A (a circular mark in the example of FIG. 1) is drawn on the preview screen (touch input screen), the CPU 11 loads in the drawing information as the additional information A regarding the subject of interest to be focused and combines and displays the drawing information at a position of the subject of interest to be focused (C component P3) (Step A7). Then, the CPU 11 detects the display position of the additional information A and temporarily stores the display position in the workspace memory 13b (Step A9), and the CPU 11 acquires the output results of the motion sensor 18, and then temporarily stores in the workspace memory 13b the output results as a later-described movement reference value (Step A10).

Also, when the touch input operation is not the operation of inputting the drawing information (Step A6, NO), the CPU 11 judges that the touch input operation is a tag selection operation in which arbitrary piece of tag information is selected by a user from a plurality of pieces of tag information prepared in advance, and the CPU 11 proceeds to the subsequent Step A8. At Step A8, the CPU 11 combines and displays the piece of tag information selected by the tag selection operation at the position of the subject of interest to be focused, as the additional information A of the subject of interest to be focused. When a subject selection operation is performed in which the position of the subject of interest to be focused is touched after the completion of the tag selection operation, the CPU 11 combines and displays the piece of the tag information selected by the tag selection operation at the position of the subject of interest to be focused.

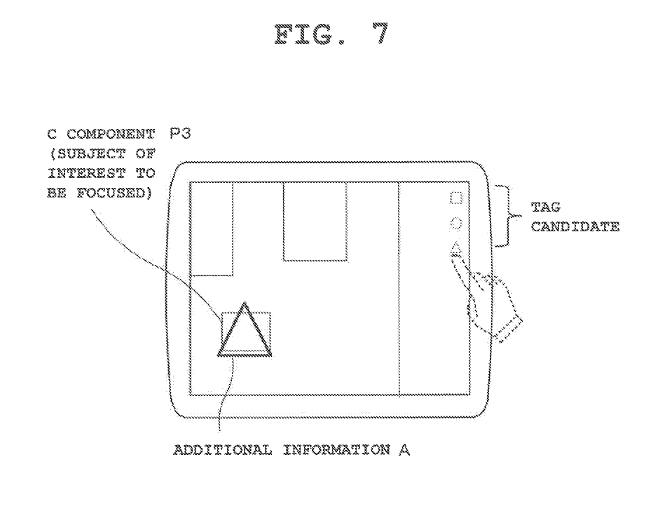

FIG. 7 is a diagram illustrating a display state in a case where the tag information selected as the additional information A is combined and displayed in the captured image.

In the example of FIG. 7, marks of three types (circle, square, and triangle) are arranged and displayed as a tag selection candidate at the right end portion in the preview screen. When the position of an arbitrary tag selection candidate, among from these tag selection candidates, that is, the position of “triangle” mark is touched, the tag information of the “triangle” mark is combined and displayed as the additional information A of the subject of interest to be focused (C component P3). Then, the CPU 11 temporarily stores the display position of the additional information A in the workspace memory 13b (Step A9), and then acquires the output results of the motion sensor 18 and temporarily stores in the workspace memory 13b the output results as a later-described movement reference value (Step A10).

Thus, after combining and displaying the additional information A, the CPU 11 proceeds to Step A11 in FIG. 5 and acquires the output results of the motion sensor 18. Then, the CPU 11 uses, as the movement reference value, the output results (a value temporarily stored in the workspace memory 13b) of the motion sensor 18 at the time point when the aforementioned additional information A is combined and displayed, and judges whether or not there has occurred change in the imaging direction of the camera section 16 based on the movement or inclination of the tablet terminal apparatus 1 in the three-dimensional space (Step A12). That is, the CPU 11 judges whether or not the imaging direction has been changed with reference to the output results of the motion sensor 18 at the time point when the additional information A is combined and displayed, based on the movement or inclination of the tablet terminal apparatus 1.

Herein, when there occurs no change in the imaging direction of the camera section 16 (Step A12, NO), the CPU 11 judges whether or not the composite imaging mode has been cancelled, thereby being completed (Step A15). When the current mode remains set to the composite imaging mode (Step A15, NO), the CPU 11 returns the process to Step A4 in FIG. 4 and judges whether or not the touch input operation is performed. Also, when there occurs change in the imaging direction of the camera section 16 (Step A12, YES), the CPU 11 performs the process of correcting the display position of the additional information A, in order to have the additional information A to follow the positional change of the subject of interest to be focused in the captured image (preview image) (Step A13).

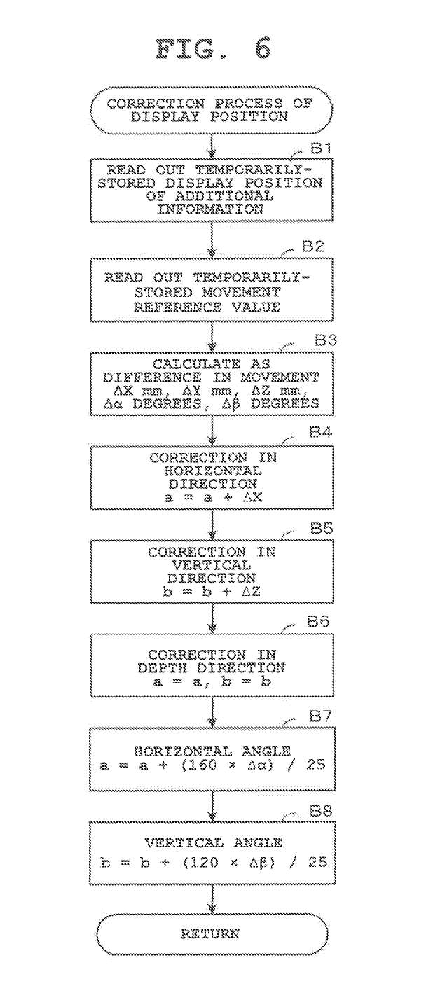

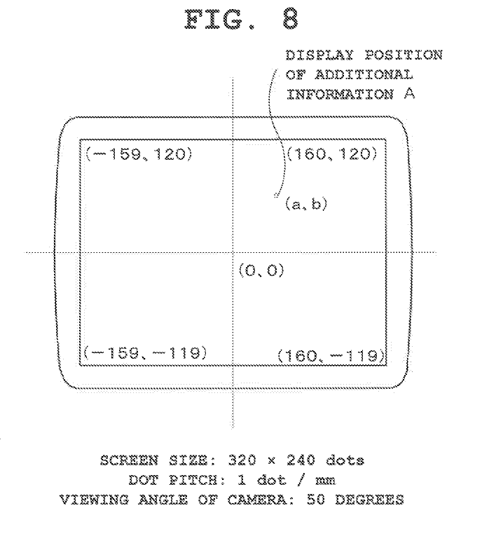

FIG. 6 is a flowchart for describing the process of correcting the display position of the additional information A (Step A13 in FIG. 5) in detail. In the process of FIG. 6, the CPU 11 calculates the display position of the additional information A in consideration of the screen size and dot pitches of the display panel 15a and the viewing angle of the camera section 16, in order to have the additional information A to follow the positional change of the subject of interest to be focused. That is, the correction process of FIG. 6 is performed corresponding to the specific example of FIG. 8. FIG. 8 is a diagram specifically illustrating the screen size and the like, in which the screen size is “320×240 dots”, the dot pitch is “1 dot/mm”, and the viewing angle of the camera is “50 degrees”. When it is assumed that the central portion of the screen of the display panel 15a is the origin (0, 0) of the two dimensional coordinate, the positional coordinates of the four corners of the screen are respectively represented such that the upper left coordinate is “−159, 120”, and the upper right coordinate is “160, 120”, and the lower left coordinate is “−159, −119”, and the lower right coordinate is “160, −119”. In the diagram, (a, b) represents the display position of the additional information A.

In this case, the CPU 11 converts the amount of change in the imaging direction corresponding to the amount of movement or inclination of the tablet terminal apparatus 1 into the amount of change on the screen and adds the amount of change to the display position (original display position) of the additional information A which is temporarily stored in the workspace memory 13b. As a result, the display position of the additional information A is updated and corrected to a new display position. That is, first, the CPU 11 reads out the display position (a, b) of the additional information A at the time point when the additional information A is combined and displayed, from the workspace memory 13b (Step B1) and reads out the output results (the movement reference value temporarily stored in the workspace memory 13b) of the motion sensor 18 at the time point when the additional information A is combined and displayed (Step B2).

Then, after the CPU 11 calculates a movement distance (ΔX mm) in the horizontal direction, a movement distance (ΔZ mm) in the vertical direction, a movement distance (ΔY mm) in the depth direction, a horizontal angle (Δα degrees), and a vertical angle (Δβ degrees) as a difference in the movement (amount of movement) in the three-dimensional space (Step B3), the CPU 11 performs the calculation of “a=a+ΔX” as the correction in the horizontal direction (Step B4), the calculation of “b=b+ΔZ” as the correction in the vertical direction (Step B5), and the calculation of “a=a, b=b” as the correction in the depth direction (Step B6). Furthermore, the CPU 11 performs the calculation of “a=a+(160×Δα)/25” in consideration of the horizontal angle (Step B7) and the calculation of “b=b+(120×Δβ)/25” in consideration of the vertical angle (Step B8). Note that the aforementioned “25” represents “½×the viewing angle of the camera”.

When the aforementioned correction process is completed (Step A13 in FIG. 5), the CPU 11 combines and displays the additional information A at a new display position (a, b) which is corrected (Step A14). Accordingly, the content of the preview screen is, for example, changed from the state in portion (a) of FIG. 1 to the state in portion (b) of FIG. 1. Hereinafter, the CPU 11 repeats the aforementioned operations until the composite imaging mode is cancelled, thereby being completed (Step A15). At present, when the completion of the composite imaging mode is instructed through the user's operation (Step A15, YES), after completing the imaging operation and the preview display operation (Step A16), the CPU 11 causes the present process to exit the flows in FIG. 4 and FIG. 5.

As is described above, in the first embodiment, when the additional information A regarding the object of interest to be focused in the captured image displayed on the touch display section 15 is arbitrarily designated through the user's operation, the CPU 11 of the tablet terminal apparatus 1 associates the additional information A with the object of interest to be focused, both of which are combined and displayed in the captured image. Additionally, when the positional change of the object of interest to be focused is detected, the CPU 11 changes the display position of the additional information A in accordance with the positional change of the object of interest to be focused, whereby the additional information A is combined and displayed in the captured image. Accordingly, when arbitrary additional information A which the user desires is added to the object of interest to be focused in the captured image, and then the position of the object of interest to be focused in the captured image is changed, the additional information A can follow the change in position of the object of interest to be focused in the captured image, and the association between the object of interest to be focused and the additional information A can be maintained at all times.

In a state where the captured image captured by the camera section 16 is displayed on the touch display section 15, the additional information A regarding the subject of interest to be focused is associated with the subject of interest to be focused (object of interest to be focused) in the captured image, and the additional information A is combined with the subject and displayed in the captured image. As a result, the user can check the additional information A regarding the subject of interest to be focused while imaging the subject.

The positional change of the subject in the captured image is detected by detecting the change in the imaging direction of the camera section 16. As a result, even when the position of the subject in the captured image is changed due to the change in the imaging direction while the user is imaging, the additional information A can follow the positional change of the subject.

The movement or inclination of the tablet terminal apparatus 1 is detected by the motion sensor 18, whereby the change in the imaging direction of the camera section 16 is detected. As a result, the change in the imaging direction can be easily and reliably detected.

In the state where the captured image is displayed on the touch display section 15, information which is arbitrarily drawn and associated with the subject of interest to be focused in the captured image is combined and displayed in the captured image, as the additional information A regarding the subject. As a result, any information which the user desires can be immediately and easily inputted on the spot as the additional information A.

In the state where a plurality of pieces of tag information are arranged and displayed on the touch display section 15, a piece of tag information which is arbitrarily selected from the plurality of pieces of tag information through the user's operation is combined and displayed in the captured image, as the additional information A regarding the subject of interest to be focused. As a result, even when the additional information A is complicated, the additional information A can be easily added through the tag selection operation.

The additional information A is combined and displayed at the position of the subject which is arbitrarily designated through a user's operation as a subject of interest to be focused. As a result, the subject of interest to be focused can be appropriately selected, and the additional information A can be combined and displayed.

When the additional information A is combined and displayed, the display position of the additional information A is temporarily stored in the workspace memory 13b, and the display position is corrected in accordance with the positional change of the object of interest to be focused, thereby being changed. As a result, the display position can be easily changed.

The captured image, in which the additional information A is associated with the subject of interest to be focused and combined with the subject, is transmitted to the PC 2 on the side of the headquarters, which is a communication counterpart. As a result, the captured image in which the additional information A is combined with the subject can be shared on both sides of the repair site and the headquarters.

Note that in the aforementioned first embodiment, the present embodiment is applied to the business communication system in the case where business communication is performed between the tablet terminal apparatus 1 on the side of the repair site where the electrical products are repaired on a visit and the PC 2 on the side of headquarters. Needless to say, the present invention is not limited thereto. Also, as the subject, for example, persons, pets, products, and buildings may be included. Also, the additional information A is not limited to the drawing information such as marks, symbols, and characters, which are arbitrarily drawn by hand, or the tag information such as the character strings and symbols which are prepared in advance, but may include information inputted through the key operation.

### Second Embodiment

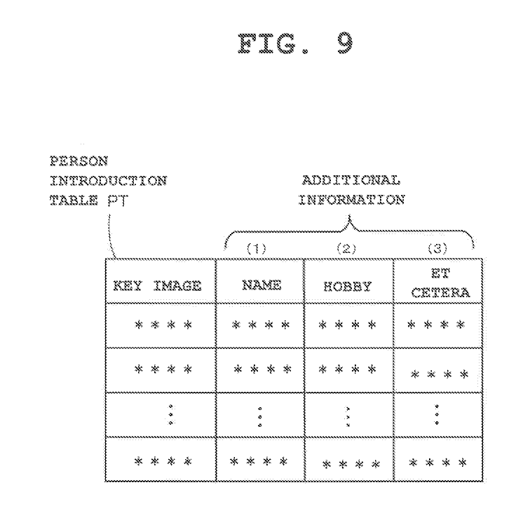

Hereinafter, the second embodiment of the present invention will be described referring to FIG. 9 to FIG. 13A and FIG. 13B. Note that, in the aforementioned first embodiment, in the state where the captured image captured by the camera section 16 is displayed on the preview screen, the positional change of the subject of interest to be focused is detected in accordance with the change in the imaging direction of the camera section 16, and the display position of the additional information A is changed in accordance with the positional change of the subject. However, in the second embodiment, the object of interest to be focused (a later-described registered person) is recognized while a moving image is analyzed during the playback of the moving image (captured image), and the positional change of the object of interest to be focused is detected, and the display position of the additional information A is changed in accordance with the positional change of the object. Note that sections that are basically the same or have the same name in both embodiments are given the same reference numerals, and therefore explanations thereof are omitted. Hereafter, the characteristic portion of the second embodiment will mainly be described.

In the first embodiment, the present invention has been applied to the communication system (business communication system) in the case where business communication is performed between the repair site and the headquarters. In the second embodiment, the present invention is applied, for example, to a communication system (person introduction system) in a case where the user introduces his or her family members, etc. to friends or acquaintances. When registered persons (an object of interest to be focused) such as a family member appear during the playback of the moving image (captured image), the additional information A to introduce the registered person is combined and displayed in the playback screen, and the composite image is transmitted to a terminal on the side of a counterpart (not shown).

FIG. 9 is a diagram for describing a person introduction table PT provided in the storage section 13. The person introduction table PT is a table to introduce a person, who appears during the playback of the moving image, to friends or acquaintances. The person introduction table PT includes items such as “key images” and “additional information”, and the content of the items is information which arbitrarily set in advance through the user's operation. “Key images” are, for example, the facial images of persons constituting the family or images having characteristic features and used as a key to search whether or not the family members have appeared during the playback of the moving image. “Additional information” is the person introduction information including a plurality of items such as “name”, “hobby”, and “job” shown in FIG. 9. Each item of “name”, “hobby”, and “job” is selected and designated through the user's operation at an arbitrary timing or at a regular time interval, for example, in the order of items (1), (2), and (3) from the starting item, and sequentially combined and displayed in the playback screen.

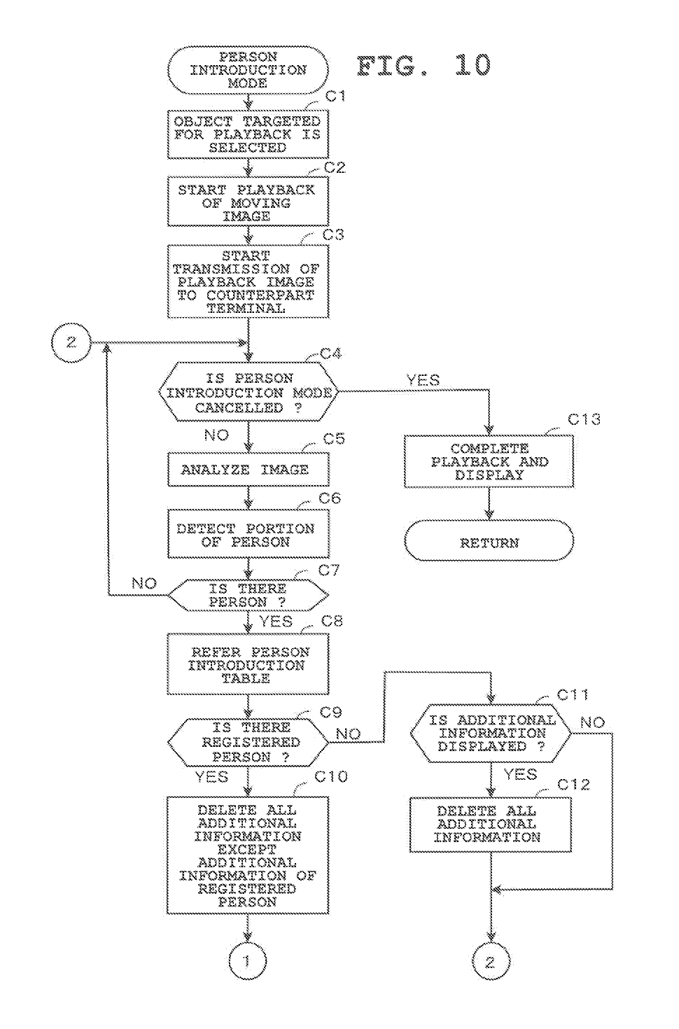

FIG. 10 to FIG. 12 are flowcharts illustrating operations which is started in the case of switching to a person introduction mode in the second embodiment. The person introduction mode is a playback mode to introduce his or her family members to friends or acquaintances. The person introduction mode can be switched as one of playback modes through the operation of the aforementioned mode switching key. When the present mode is switched to the person introduction mode, the CPU 11 of the tablet terminal apparatus 1 displays a list of moving images on the touch display section 15, thereby putting the moving images targeted for the playback into an arbitrarily selectable state. When the moving image targeted for the playback is selected from the list through the user's operation (Step C1 in FIG. 10), the CPU 11 starts the playback operation of the selected moving image (Step C2). Then, the CPU 11 starts the operation of transmitting the moving image started and played back to the terminal on the side of the counterpart (Step C3). In this case, the terminal (not shown) on the side of the counterpart starts the operation of sequentially displaying the moving image received from the tablet terminal apparatus 1 on its own screen.

Next, the CPU 11 judges whether or not the person introduction mode has been cancelled, thereby being completed (Step C4). When the current mode remains set to the person introduction mode (Step C4, NO), the CPU 11 analyzes the moving image during the playback (Step C5) and detects the image portion of the person (Step C6). In this case, the CPU 11 comprehensively judges the shape, magnitude, arrangement relations of constituting portions (head, face, eyes, nose, hands, and legs) of the person and detects the image portion (any of a full length image, a half-length image, a facial image) of the person. However, the method of the detection is arbitrary. When the image portion of the person is not detected, that is, when the person is not included in the moving image (Step C7, NO), the CPU 11 returns the process to Step C4 and repeats the aforementioned operation hereafter until the CPU 11 analyzes the image and detects the image portion of the person.

In contrast, when the person is included in the moving image, and the image portion of the person is detected (Step C7, YES), the CPU 11 refers to “key images” in the person introduction table PT based on the image portion of the person (Step C8) and judges whether the image portion corresponds to any of “key images”, that is, whether the registered person (an object of interest to be focused) registered in the person introduction table PT is included in the moving image during the playback (whether the person has been specified) (Step C9). Note that, when a plurality of persons are included in the moving image during the playback, the CPU 11 repeats the operation of judging whether or not the person is a registered person while referring to the person introduction table PT for every person.

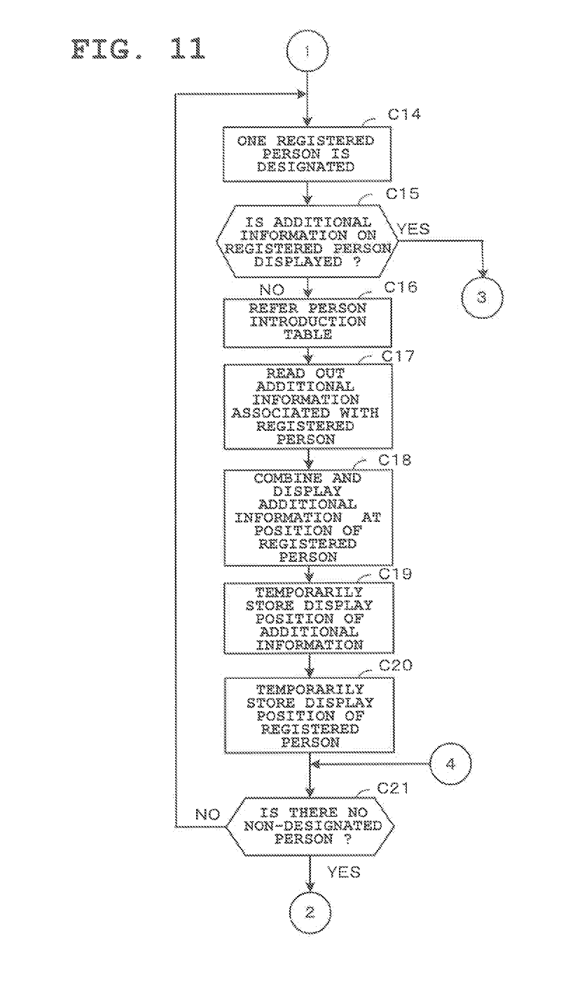

When the registered person (s) are included in the moving image which is currently being played back (Step C10, YES), the CPU 11 deletes all the additional information A except the additional information on the registered person(s) (additional information on a person who has exited and been out of the playback screen), out of the additional information A which is being displayed on the playback screen (Step C10). Then, the CPU 11 proceeds to Step C14 in FIG. 11 and designates one person from the specified registered person (s). And then, the CPU 11 judges whether the additional information A associated with the person is displayed (Step C15). When the additional information A is not displayed (Step C15, NO), the CPU 11 judges that it is a time when the person appears and proceeds to the processes in which the additional information A is newly combined and displayed with respect to the image of the person (Steps C16 to C20).

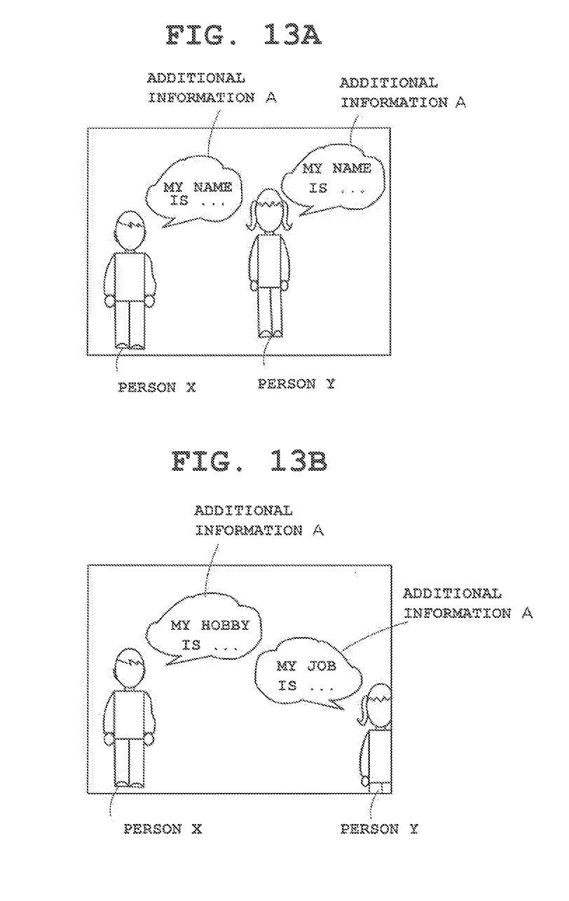

First, the CPU 11 refers to the person introduction table PT (Step C16), reads out the additional information A associated with the specific person (registered person) (Step C17), and combines and displays the additional information A at the display position of the registered person (Step C18). In this case, at first, the CPU 11 reads out the additional information A of the starting item, out of the additional information A of the plurality of items and combines and displays the additional information A at the display position of the registered person. FIG. 13A is a diagram illustrating a case where the additional information A is combined and displayed at the display position of the registered person. The example of FIG. 13A represents a case where “person X” and “person Y” appear on the playback screen as the registered persons, in which “My name is . . . ” is displayed as the additional information A of the starting item corresponding to “person X”, and “My name is . . . ” is displayed as the additional information A of the starting item corresponding to “person Y”. Then, the CPU 11 temporarily stores the display position of the additional information A in the workspace memory 13b (Step C19) and temporarily stores the display position of the registered person(s) in the workspace memory 13b (Step C20).

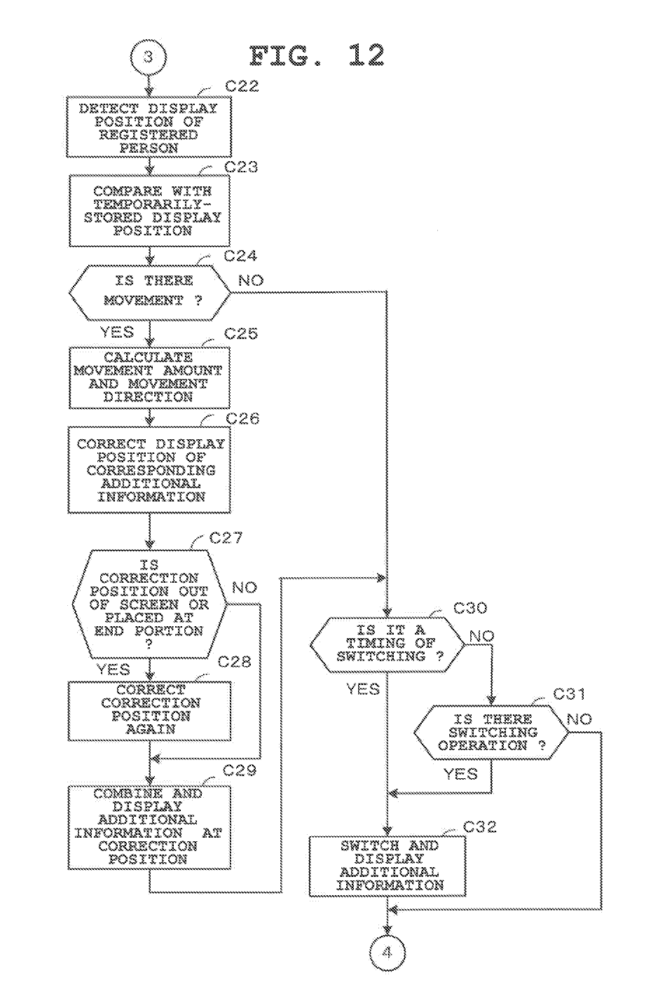

Hereafter, the CPU 11 judges whether or not a non-designated person(s) who have not been designated are presented, out of the registered persons, that is, whether or not all the registered persons have been designated (Step C21). When there still remains a non-designated person (s) (Step C21, NO), the CPU 11 returns to the aforementioned Step C14, designates the next registered person, and performs the similar operation afterwards. In contrast, when the additional information A is displayed on the designated person (Step C15, YES), the CPU 11 proceeds to the flow in FIG. 12. Specifically, the CPU 11 detects the current display position of the registered person (Step C22), reads out the display position of the registered person at a time when the additional information A is newly combined and displayed, from the workspace memory 13b, compares the display position of the registered person which is read out from the workspace memory 13b, with the currently detected display position of the registered person (Step C23), and judges whether or not the registered person has moved in the playback screen (Step C24).

Herein, when the registered person does not move (Step C24, NO), the CPU 11 proceeds to a later-described Step C30. When the CPU 11 detects the movement of the registered person (Step C24, YES), the CPU 11 calculates the amount of movement and the moving direction of the registered person on the playback screen (Step C25), reads out the display position of the additional information A at a time when the additional information A is newly combined and displayed, from the workspace memory 13b, and corrects the display position in accordance with the amount of movement and the moving direction calculated (Step C26). Note that the calculation of the amount of movement and the moving direction is, for example, performed such that the amount of movement and the moving direction are calculated on the coordinate system in which the central portion of the playback screen is the origin, but the method of the calculation is arbitrary.

Accordingly, when correcting the display position of the additional information A, the CPU 11 judges whether or not correction position is out of the screen or is placed at an end portion of the screen (Step C27). When the correction position is not out of the screen or is not placed at the end portion of the screen (Step C27, NO), the additional information A is combined and displayed at the correction position (Step C29). In contrast, when the correction position of the additional information A is out of the screen or placed at the end portion of the screen (Step C27, YES), the CPU 11 corrects the correction position again such that the correction position is placed close to the center of the screen (Step C28), and then, combines and displays the additional information A at the correction position (Step C29). For example, in FIG. 13B, in the case where the registered person “person Y” moves to the end portion of the playback screen and a portion of the person is displayed, when the additional information A follows the movement of “person Y” and moves in a state where the arrangement of “person Y” and the additional information is maintained, the additional information A goes out of the screen. Accordingly, the CPU 11 corrects the correction position again such that the display position of the additional information A is placed close to the center of the playback screen.

Subsequently, the CPU 11 judges whether or not it is a timing of automatically switching the additional information A (Step C30) and judges whether the operation of arbitrarily switching the additional information A has been performed through the user's operation (Step C31). That is, the CPU 11 judges whether or not a predetermined period of time (for example, five seconds) has elapsed from the time when the additional information A is newly combined and displayed (whether or not it is a timing of switching the additional information A), with respect to all the additional information A which is being displayed, or the CPU 11 judges whether or not arbitrary additional information A has been designated by contact through the touch operation on the touch screen (the switching of the additional information A is instructed through the user's operation).

At present, when the timing of switching the additional information A is detected (Step C30, YES), or when the switching operation is detected (Step C31, YES), the CPU 11 reads out the item subsequent to the item which is currently displayed, out of the respective items of the additional information A, from the person introduction table PT, and then switches the current item to the subsequent item and display the subsequent item (Step C32). As illustrated in FIG. 13A and FIG. 13B, for example, the additional information A on the registered person “person X” is changed from “My name is . . . ” to “My hobby is . . . ”, and the additional information A on the registered person “person Y” is changed from “My name is . . . ” to “My job is . . . ”. Hereinafter, the CPU 11 returns to Step C21 in FIG. 11 and repeats the aforementioned operation (Steps C14 to C20 in FIG. 11 or Steps C22 to C32 in FIG. 12) until the designation of all the registered persons is completed.

Accordingly, the designation of all the registered persons is completed (Step C21, YES), the CPU 11 returns to Step C4 in FIG. 10. Herein, when the current mode remains set to the person introduction mode (Step C4, NO), the CPU 11 analyzes the image and detects whether or not the registered person has been included in the image as described above (Steps C5 to C9). When the registered person is not specified (Step C9, NO), the CPU 11 judges whether or not the additional information A has been displayed in the playback screen (Step C11). When the additional information A is displayed in the playback screen (Step C11, YES), the CPU 11 deletes all the display of the additional information A (Step C12), and then, the CPU 11 returns to the aforementioned Step C4. Also, when the person introduction mode is cancelled and the completion of the person introduction mode is instructed (Step C4, YES), the CPU 11 completes the playback operation and the display operation (Step C13), and then, the CPU 11 exits the flows of FIG. 10 to FIG. 12.

As is described above, in the second embodiment, the CPU 11 analyzes the image (moving image) targeted for the playback and recognizes the person (object of interest to be focused) in the captured image. Then, CPU 11 tracks and detects the position of the person, thereby detecting the positional change of the person in the captured image. As a result, CPU can change the display position of the additional information A in accordance with the positional change. As a result, the positional change of the person can be detected without the use of the specific sensors and the like, and the additional information A can follow the image of the person corresponding to the movement of the person in the captured image. Accordingly, the association between the person and the additional information A can be maintained at all times.

When the plurality of persons are included in the captured image, the CPU 11 tracks and detects the position of each person, and then the CPU 11 specifies a person, whose position is changed, out of the plurality of persons, and detects the positional change of the person, thereby changing the display position of the additional information A in accordance with the positional change. Accordingly, regarding only a person who moves in the captured image, out of the plurality of persons included in the captured image, the additional information A of the person can follow the person and move.

The CPU 11 specifies the person by analyzing the image of the person, reads out the additional information A associated with the person from the person introduction table PT, and combines and displays the additional information A associated with the person. As a result, the additional information A prepared in advance can be easily combined and displayed without the use of the user's operation.

When the plurality of persons are specified by analyzing the images of the persons, the CPU 11 repeats the operation in which the additional information A associated with the persons is read out from the person introduction table PT and is combined and displayed for every person. As a result, even when the plurality of persons are included in the image, the additional information A can be displayed.

In the state where the additional information A including the plurality of items is stored for each person in the person introduction table PT, the CPU 11 sequentially reads out the plurality of items included in the additional information A from the person introduction table PT, whereby the plurality of items is sequentially combined and displayed. As a result, the user who visually recognizes the image can sequentially check the plurality of items included in the additional information A for each person and can check a lot of information even on a small-size screen.

When the display position of the additional information A is changed, and the position after the position of the additional information is changed goes out of the playback screen, the CPU 11 changes the display position of the additional information A again such that the additional information A is within the screen on condition that a portion of the person exists in the screen. Accordingly, even when a portion of the person goes out of the screen, the additional information A can be displayed at an easily viewable position.

Also, the composite image in which the additional information A is combined and displayed while being associated with the person is transmitted to a counterpart's terminal. Accordingly, the image combined with the additional information A can be shared with the counterpart.

In the aforementioned second embodiment, the moving image (captured image) is played back. However, the present invention is not limited to the playback of the moving image (captured image). It may be television images received by television broadcasts. In this case, the television images are analyzed, and the registered persons (for example, favorite singers and athletes) registered in advance are detected, and the additional information A, which is prepared in advance and associated with the person, is read out, combined, and displayed at a time when the person is detected.

Also, in the aforementioned second embodiment, when a registered person appears in the image, the registered person is judged as an object of interest to be focused. However, when a person (an unknown person) except the registered appears, the additional information A for informing the user that the person who appears in the image is unknown, may be combined and displayed. Also, the object of interest to be focused is not limited to the persons, but may be pets and vehicles, for example. Also, the additional information A may be drawing information such as marks, symbols, and characters which are arbitrarily drawn by hand.

Moreover, in the aforementioned embodiment, the present invention is applied to the tablet terminal apparatus 1 as an image display apparatus. However, the present invention is not limited thereto. The present invention may be applied to a personal computer, PDA (personal, portable information communication equipment), a digital camera, music players, an electronic game machine, a television receiver, a projector, or the like.

Furthermore, the “apparatuses” or the “sections” described in the above-described embodiment are not required to be in a single housing and may be separated into a plurality of housings by function. In addition, the steps in the above-described flowcharts are not required to be processed in time-series, and may be processed in parallel, or individually and independently.

While the present invention has been described with reference to the preferred embodiments, it is intended that the invention be not limited by any of the details of the description therein but includes all the embodiments which fall within the scope of the appended claims.

What is claimed is:

1. An image display apparatus which displays images on a display section, comprising:
a first display control section which associates an object of interest to be focused in an image displayed on the display section with additional information regarding the object of interest to be focused, combines the object with the additional information, and display the additional information in the image;
a detection section which detects positional change of the object of interest to be focused in the image; and
a second display control section which changes a display position of the additional information in accordance with the positional change of the object of interest to be focused, which is detected by the detection section, combines the additional information with the object of interest to be focused, and displays the additional information in the image.

2. The image display apparatus according to claim 1, further comprising a imaging section which captures an image,
wherein the first display control section associates, on a live view display screen on which the captured image captured by the imaging section is displayed as a live view display image on the display section, a subject of interest to be focused, which is the object of interest to be focused in the captured image, with the additional information, combines the subject with the additional information regarding the subject, and displays the additional information regarding the subject in the captured image.

3. The image display apparatus according to claim 2, wherein the detection section detects change in an imaging direction where the imaging section captures, thereby detecting positional change of the subject in the captured image.

4. The image display apparatus according to claim 3, wherein the detection section detects at least any of a movement in a right-and-left direction, a movement in an up-and-down direction, an inclination in the right-and-left direction, and an inclination in a front-and-back direction, thereby detecting the change in the imaging direction where the imaging section captures.

5. The image display apparatus according to claim 1, wherein the detection section recognizes the object of interest to be focused while analyzing the image, and tracks and detects a position of the object of interest to be focused, thereby detecting a positional change of the object of interest to be focused in the image.

6. The image display apparatus according to claim 5, wherein the detection section, when a plurality of objects of interest to be focused are included in the image, tracks and detects a position of each of the plurality of objects of interest to be focused, thereby specifying an object of interest to be focused, whose position is changed, out of the plurality of objects of interest to be focused, and detecting the positional change of the object of interest to be focused.

7. The image display apparatus according to claim 1,
wherein the display section is a touch display section which includes a touch screen on which input can be performed by contact, and
wherein the first display control section, in a state where the image is displayed on the touch screen of the touch display section, associates information arbitrarily drawn with the object of interest to be focused on the touch screen, combines the information arbitrarily drawn with the object of interest to be focused, and displays the information arbitrarily drawn in the image as the additional information regarding the object of interest to be focused.

8. The image display apparatus according to claim 1, wherein the first display control section, in a state where a plurality of pieces of tag information are placed and displayed on a screen of the display section, associates a piece of tag information arbitrarily selected through a user's operation with the object of interest to be focused in the image, out of the plurality of pieces of tag information placed and displayed on the screen of the display section, combines the piece of tag information arbitrarily selected with the object of interest to be focused, and displays the piece of tag information arbitrarily selected in the image as the additional information regarding the object of interest to be focused.

9. The image display apparatus according to claim 1, wherein the first display control section associates the additional information with the object of interest to be focused, which is arbitrarily designated through a user's operation, combines the additional information with the object of interest to be focused, and displays the additional information in the image.

10. The image display apparatus according to claim 1, further comprising a storage section which temporarily stores the display position of the additional information,
wherein the second display control section corrects the display position of the additional information temporarily stored in accordance with the positional change of the object of interest to be focused, which is detected by the detection section, thereby changing the display position of the additional information.

11. The image display apparatus according to claim 1, further comprising an additional information storage section which associates the additional information with the object of interest to be focused in advance and stores the additional information regarding the object of interest to be focused,
wherein the first display control section specifies the object of interest to be focused by analyzing the image, reads out the additional information corresponding to the object of interest to be focused, from the additional information storage section, combines the additional information with the object of interest to be focused, and displays the additional information in the image.

12. The image display apparatus according to claim 11,
wherein the additional information storage section associates the additional information regarding respective objects of interest to be focused with the respective objects of interest to be focused and stores the additional information, and
wherein, when the first display control section specifies a plurality of objects of interest to be focused by analyzing the image, the first display control section repeats operations of reading out the additional information corresponding to each of the plurality of objects of interest to be focused from the additional information storage section, combining the additional information with the each of the plurality of objects of interest to be focused, and displaying the additional information, for the each of the plurality of objects of interest to be focused.

13. The image display apparatus according to claim 11,
wherein the additional information storage section stores the additional information including a plurality of items for every object of interest to be focused, and
wherein the first display control section sequentially reads out the plurality of items included in the additional information, corresponding to the specified object of interest to be focused, from the additional information storage section, thereby sequentially combining the plurality of items included in the additional information with the specified object of interest to be focused and sequentially display the plurality of items included in the additional information.

14. The image display apparatus according to claim 1, wherein, when the second display control section changes the display position of the additional information in accordance with the positional change of the object of interest to be focused, and a position after the display position of the additional information is changed goes out of a screen of the display section, the display position is changed again such that the additional information is within the screen, on condition that at least a portion of the object of interest to be focused exists on the screen of the display section.

15. The image display apparatus according to claim 1, further comprising a transmission section which transmits the image, in which the additional information is associated and combined with the object of interest to be focused, to an external display apparatus on a side of a communication counterpart.

16. A method with respect to an image display apparatus which displays images on a display section, the method comprising:
a display step of associating an object of interest to be focused in an image displayed on the display section with additional information regarding the object of interest to be focused, combining the object with the additional information, and displaying the additional information in the image;
a detection step of detecting positional change of the object of interest to be focused in the image; and
a composite display step of changing a display position of the additional information in accordance with the positional change of the object of interest to be focused, which is detected at the detection step, combining the additional information with the object of interest to be focused, and displaying the additional information in the image.
